(19) United States
(12) Patent Application Publication
(10) Pub. No.: US 2018/0277005 A1
(43) Pub. Date: Sep. 27, 2018

(54) QUESTION SELECTION AND LAYOUT

(71) Applicant: Hewlett-Packard Development Company, L.P., Houston, TX (US)

(72) Inventors: Robert B. Taylor, Vancouver, WA (US); Udi Chatow, Palo Alto, CA (US); Bruce Williams, San Diego, CA (US)

(21) Appl. No.: 15/761,487

(22) PCT Filed: Dec. 18, 2015
(86) PCT No.: PCT/US2015/066894

§ 371 Date: Mar. 20, 2018

(51) Int. Cl. G09B 7/02; G09B 7/06; G06K 19/06

(52) U.S. Cl. CPC G09B 7/02; G09B 7/06; G06K 9/00442; G06K 19/06037; G06K 2209/01; G06K 19/06028

(57) ABSTRACT

Examples disclosed herein relate to selecting a plurality of questions in a random order, generating a printable layout of the selected plurality of questions, associating a unique identifier with the selected plurality of questions, and adding a machine-readable code of the unique identifier to the printable layout.

### BACKGROUND

In some situations, a set of questions may be created, such as for a test or survey. The questions may also be paired with an answer key and/or may be associated with free-form answer areas. For example, some questions may be multiple choice while others may be fill-in-the-blank and/or essay type questions.

### BRIEF DESCRIPTION OF THE DRAWINGS

In the accompanying drawings, like numerals refer to like components or blocks. The following detailed description references the drawings, wherein:

FIG. 1 is a block diagram of an example test generation device;

FIGS. 2A-2C are illustrations of example machine-readable codes;

FIG. 3 is an illustration of an example generated test;

FIG. 4 is a flowchart of an example of a method for providing test generation; and

FIG. 5 is a block diagram of an example system for providing test generations.

### DETAILED DESCRIPTION

In some situations, a set of questions may be prepared to be presented and answered by one and/or more recipients. The questions may comprise multiple choice, fill-in-the-blank, essay, short answer, survey, rating, math problems, and/or other types of questions. For example, a teacher may prepare a set of 25 questions of various types for a quiz.

Conventional automated scoring systems, such as Scantron® testing systems, may compare answers on a carefully formatted answer sheet to an existing answer key, but such sheets must be precisely filled in with the correct type of pencil. Further, such sheets rely on a known order of the questions. This allows for easy copying of answers from one student to another and also introduces errors when a student fails to completely fill out the bubbles to mark their answers.

Randomizing the question order will greatly reduce the incidence of cheating and copying among students. Further, the ability to recognize which questions appear in any order allows for automated collection of answers to each question. In some implementations, not only multiple choice answers may be graded, but textual answers, such as fill in the blank responses, may be recognized using optical character recognition (OCR) and compared to stored answers.

Each student may be associated with a unique identifier that may be embedded in the test paper. Such embedding may comprise an overt (plain-text) and/or covert signal such as a watermark or matrix code. Since every paper may comprise a unique code with a student identifier and/or a test version #, a different test sequence may be created per student, making it hard or impossible to copy from student neighbors while still enabling an automated scan and assessment solution. The automated assessment may give immediate feedback some and/or all of the questions, such as by comparing a multiple choice or OCR'd short text answer to a correct answer key. These results may, for example, be sent by email and/or to a application.

In some implementations, the test will have a combination of choosing the correct or best answer and also requesting to show and include the process of getting to the answer chosen. In other words, in some cases the form will have a question, with a set of multiple choice answers for the student to choose from and also a box to elaborate on how the student arrived at the answer. In this way, there may be an immediate response and assessment/evaluation for the student based on the multiple choice answers and a deeper feedback from the teacher that can request to evaluate all the students who had a mistake in answer #4 to see what the common mistakes were.

The paper test form may be captured in a way that each answer can be individually sent for analysis directly to the instructor/teacher or to a student's file. This may include multiple choice answers as well as the text box with the free-response text answer and/or sketch which is positioned in a predefined area and positioning on the paper test form. A scanning device may be used to capture the paper test form, such as a smartphone, tablet or similar device with a camera that can scan and capture a photo of the test form and/or a standalone scanner. Upon scanning, the paper's unique machine-readable code (e.g., watermark) may be identified and associates the answers with the student ID and the specific test sequence expected. The answers and the immediate results of the multiple choice answers may be presented and/or delivered to the student. In cases where mistakes were made, the student may receive a recommendation of content to close the knowledge gap. A teacher/instructor, in class or remotely, may review the answers and give the student additional personal feedback. In some cases, teachers would like to understand class trends and gaps by analyzing all answers to a particular question to see what common mistakes were made to help the teacher focus on the areas of weakness. The association of assessment scores to a particular student may be made via a unique and anonymized identifier associated with the test paper, which can tell which student completed an assessment via the unique identifier embedded in the assessment's machine-readable code. Since the teacher/instructor no longer has to associate an assessment with a particular student, the identity of the student who completed the assessment can be kept hidden, greatly minimizing the chance of the teacher applying personal bias while grading. Further, the teacher may choose to review all students' responses to a particular question, such as question 4, in order to focus on that answer. The teacher may then move on to reviewing all students' responses to the next question, rather than grading all of the questions on the assessment/test for each student in turn.

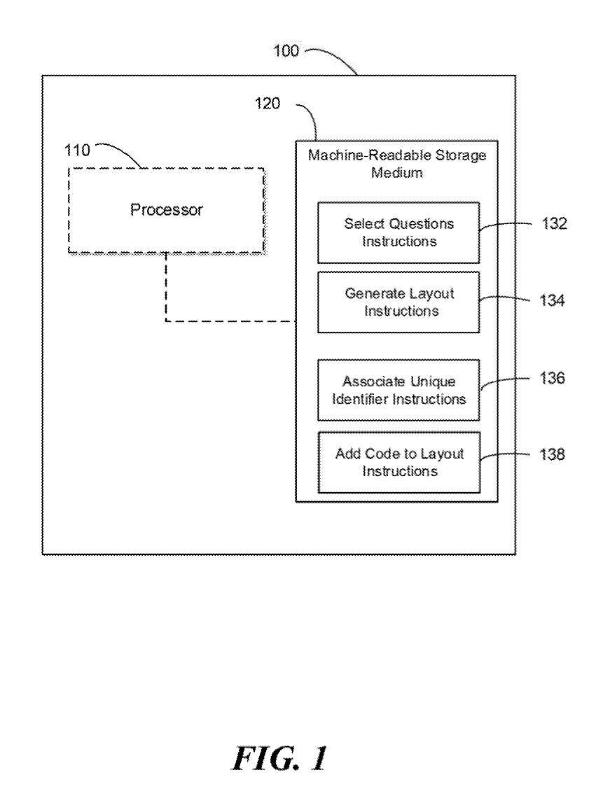

Referring now to the drawings, FIG. 1 is a block diagram of an example test generation device 100 consistent with disclosed implementations. Test generation device 100 may comprise a processor 110 and a non-transitory machine-readable storage medium 120. Test generation device 100 may comprise a computing device such as a server computer, a desktop computer, a laptop computer, a handheld computing device, a smart phone, a tablet computing device, a mobile phone, a network device (e.g., a switch and/or router), or the like.

Processor 110 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 120. In particular, processor 110 may fetch, decode, and execute a plurality of select questions instructions 132, generate layout instructions 134, associate unique identifier instructions 136, and add code to layout instructions 138 to implement the functionality described in detail below.

Executable instructions may comprise logic stored in any portion and/or component of machine-readable storage medium 120 and executable by processor 110. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Select questions instructions 132 may select a plurality of questions in a random order. The plurality of questions may comprise, for example a multiple choice question, a short answer question, a free-form question, a sketch and/or drawing question, an essay question, a question that requires showing a process or solving work, a mathematics question, etc.

Device 100 may, for example, use a random number generator to select from the list of available questions. A random number generator (RNG) may comprise a computational algorithm designed to generate a sequence of numbers that cannot be reasonably predicted better than by a random chance. For example, for available questions 1-30, a RNG may be used to generate a random number from 1 to 30; the generated number may become the first question. A second question may then be selected by using the RNG to generate a random number from 1 to 29. Alternately, another random number from 1 to 30 may be generated and a repeat simply ignored so that a new random number is generated. In some implementations, constraint rules may be applied. Such rules may state that a particular question be placed in a particular location, such as placing an essay question as the final question. Another rule may state that a particular question must precede another question, such as available question 3 should always follow available question 7. Selection of one of these questions may result in the constrained question from the rule being inserted into the question order as specified by the rule. For multiple choice questions, the RNG may similarly be used to randomize the order of the answer choices.

In some implementations, the instructions to select the plurality of questions in the random order further comprise instructions to randomize the selection of the plurality of questions for each of a plurality of students. For example, for each student, a newly randomized order of questions may be selected. For another example, a limited number of randomized order of questions may be prepared, such that some students may receive the same order (e.g., four sets of randomized questions may be prepared for a class of 16, such that every fourth student receives the same question order).

Questions may be stored in a question database associated with a teaching/instructional application. For example, an instructor may enter the questions in an app on their tablet and/or smart device, through a web-based user interface, through an application on a deskptop or laptop, etc. Each question may comprise the actual display information of the question (text, figures, drawings, references, tables, etc.), a question type (e.g., short answer, multiple choice, sketch, essay, etc.), and/or any constraint rules, as described above. For multiple-choice type questions, the answer choices may also be entered. The question type may be then be used to define an amount of space needed on a page. For example, a multiple choice question may require two lines for the question, an empty space line, and a line for the list of possible answers. For free-form and/or essay type questions, the instructor may enter a recommended amount of answer space (e.g., three lines, half a page, a full page, etc.). The instructor/teacher may also enter the correct answers into the application for later grading.

Generate layout instructions 134 may generate a printable layout of the selected plurality of questions. The instructions to generate the printable layout of the selected plurality of questions may further comprise instructions to create indicators for a pre-defined answer area for at least one of the plurality of questions. For example, a box may be drawn to indicate a sketch/drawing area and/or lines may be provided to indicate a free-form/short answer area. Other indicators may comprise arrows, bubbles, shading, number lines, etc. In some implementations, questions and answers may be laid out on different pages.

Associate unique identifier instructions 136 may associate a unique identifier with the selected plurality of questions. The unique identifier may be associated with a student and/or may identify the order of questions. For example, the randomized order of the questions may be stored in a database table and associated with a unique identifier. Upon scanning the machine-readable code, the unique identifier may be used to retrieve the expected order of questions and/or answers. In some implementations, a student identifier may be associated with the selected plurality of questions. The student identifier may be pre-assigned before the test is given to the student and/or may be associated with the selected plurality of questions later, such as when the test is handed out and/or when the answers are returned by the student.

Add code to layout instructions 138 may add a machine-readable code of the unique identifier to the printable layout. The machine-readable code may comprise, for example, a bar code, a matrix code, a text string, and a watermark. The machine-readable code may be visible to a person, such as a large bar code, and/or may not be readily visible, such as a translucent watermark and/or a set of steganography dots. The code may be used to identify the selected questions, a class period, a student, and/or additional information. In some implementations, the code may be added in multiple sections, such as a small matrix code at one and/or more of the corners of the page.

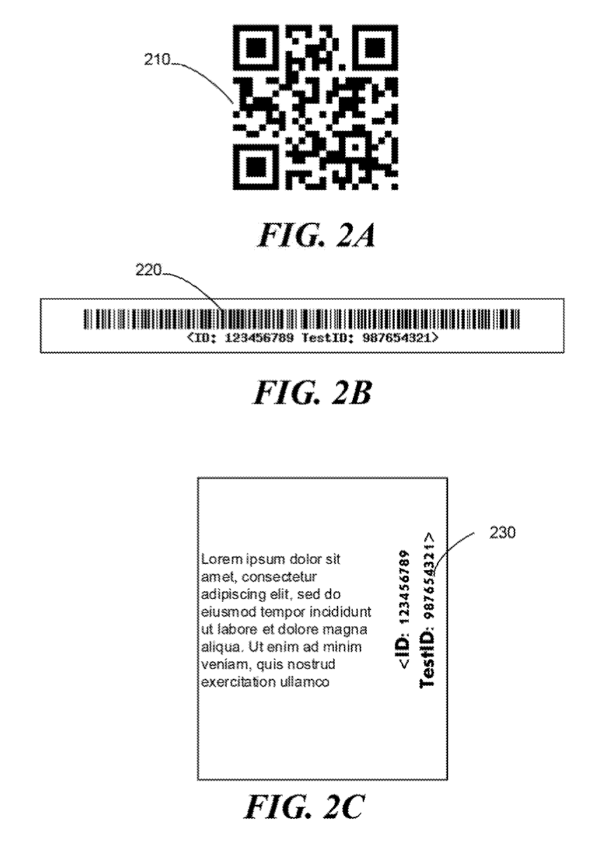

FIG. 2A is an illustration of an example machine-readable code comprising a matrix code 210.

FIG. 2B is an illustration an example machine-readable code comprising a bar code 220.

FIG. 2C is an illustration of an example machine-readable code comprising a watermark 230.

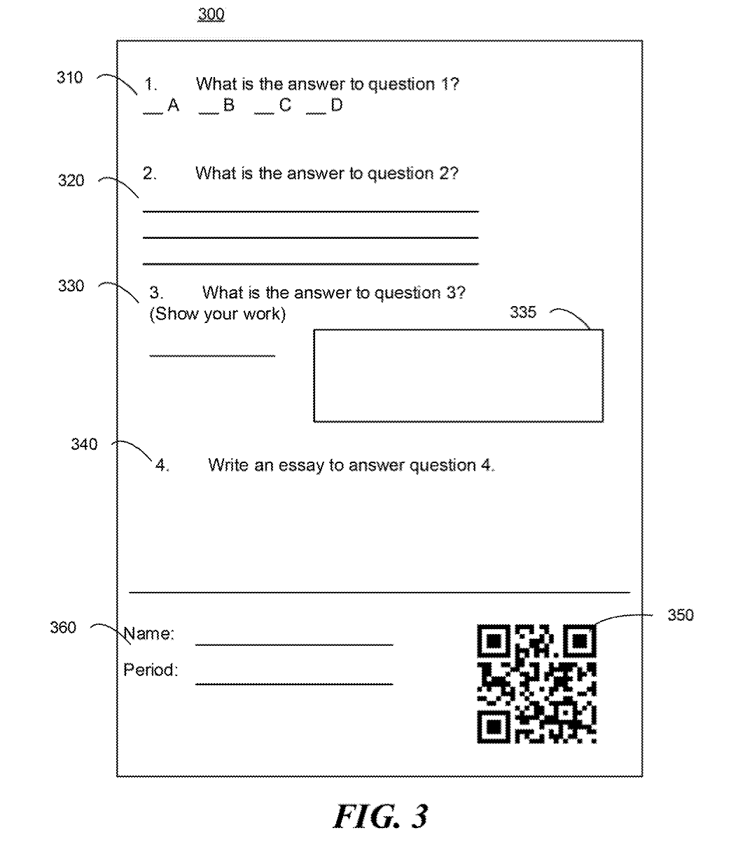

FIG. 3 is an illustration of an example generated test 300. Generated test 300 may comprise a plurality of different question types, such as a multiple choice question 310, a free-form answer question 320, a short answer question 330 with a pre-defined answer area 335, such as may be used for a sketch or to show work, and an essay question 340. Generated test 300 may further comprise a machine-readable code 350 comprising a unique identifier. Machine-readable code 350 may be displayed anywhere on the page and may comprise multiple machine-readable codes, such as a small bar or matrix code at each corner and/or a watermark associated with one, some, and/or all of the questions. Generated test 300 may further comprise a name block 360.

In some implementations, name block 360 may be omitted when a student identifier is already assigned to the generated test 300. The student identifier may, for example, be encoded into machine-readable code 350. In some implementations, name block 360 may be scanned along with the answered questions and the student's name and/or other information may be extracted and associated with the answers.

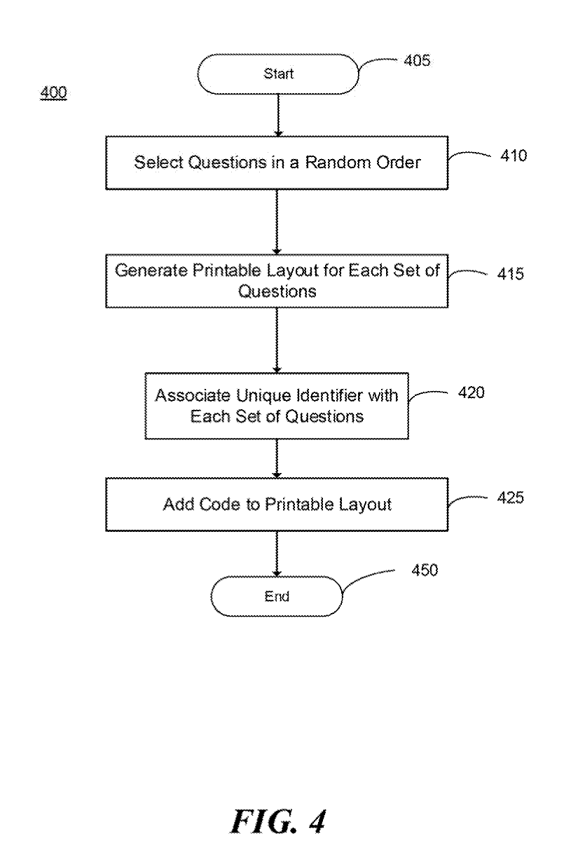

FIG. 4 is a flowchart of an example method 400 for providing test generation consistent with disclosed implementations. Although execution of method 400 is described below with reference to device 100, other suitable components for execution of method 400 may be used.

Method 400 may begin in stage 405 and proceed to stage 410 where device 100 may select a plurality of questions in a random order for each of a plurality of students. The plurality of questions may comprise, for example a multiple choice question, a short answer question, a free-form question, a sketch and/or drawing question, an essay question, a question that requires showing a process or solving work, a mathematics question, etc.

In some implementations, selecting the plurality of questions in the random order for each of the plurality of students comprises selecting a subset of an available list of questions. For example, 30 questions may be available for selection, but each test set may comprise a subset, such as 20 or 25, of the 30 questions. Some students may thus receive questions on their generated test that other students do not.

For example, select questions instructions 132 may select a plurality of questions in a random order. The plurality of questions may comprise, for example a multiple choice question, a short answer question, a free-form question, a sketch and/or drawing question, an essay question, a question that requires showing a process or solving work, a mathematics question, etc.

Device 100 may, for example, use a random number generator to select from the list of available questions. A random number generator (RNG) may comprise a computational algorithm designed to generate a sequence of numbers that cannot be reasonably predicted better than by a random chance. For example, for available questions 1-30, a RNG may be used to generate a random number from 1 to 30; the generated number may become the first question. A second question may then be selected by using the RNG to generate a random number from 1 to 29. Alternately, another random number from 1 to 30 may be generated and a repeat simply ignored so that a new random number is generated. In some implementations, constraint rules may be applied. Such rules may state that a particular question be placed in a particular location, such as placing an essay question as the final question. Another rule may state that a particular question must precede another question, such as available question 3 should always follow available question 7. Selection of one of these questions may result in the constrained question from the rule being inserted into the question order as specified by the rule. For multiple choice questions, the RNG may similarly be used to randomize the order of the answer choices.

In some implementations, the instructions to select the plurality of questions in the random order further comprise instructions to randomize the selection of the plurality of questions for each of a plurality of students. For example, for each student, a newly randomized order of questions may be selected. For another example, a limited number of randomized order of questions may be prepared, such that some students may receive the same order (e.g., four sets of randomized questions may be prepared for a class of 16, such that every fourth student receives the same question order).

Questions may be stored in a question database associated with a teaching/instructional application. For example, an instructor may enter the questions in an app on their tablet and/or smart device, through a web-based user interface, through an application on a deskptop or laptop, etc. Each question may comprise the actual display information of the question (text, figures, drawings, references, tables, etc.), a question type (e.g., short answer, multiple choice, sketch, essay, etc.), and/or any constraint rules, as described above. For multiple-choice type questions, the answer choices may also be entered. The question type may be then be used to define an amount of space needed on a page. For example, a multiple choice question may require two lines for the question, an empty space line, and a line for the list of possible answers. For free-form and/or essay type questions, the instructor may enter a recommended amount of answer space (e.g., three lines, half a page, a full page, etc.). The instructor/teacher may also enter the correct answers into the application for later grading.

Method 400 may then advance to stage 415 where device 100 may generate a printable layout for each of the selected plurality of questions. In some implementations, generating the printable layout may comprise defining a response area for the at least one free-form question and/or adding a visual indicator of the defined response area to the printable layout. For example, generate layout instructions 134 may generate a printable layout of the selected plurality of questions. The instructions to generate the printable layout of the selected plurality of questions may further comprise instructions to create indicators for a pre-defined answer area for at least one of the plurality of questions. For example, a box may be drawn to indicate a sketch/drawing area and/or lines may be provided to indicate a free-form/short answer area. Other indicators may comprise arrows, bubbles, shading, number lines, etc. In some implementations, questions and answers may be laid out on different pages.

Method 400 may then advance to stage 420 where device 100 may associate a unique identifier for each of the plurality of students with the corresponding selected plurality of questions. In some implementations, the machine-readable code may comprise information associated with the random order of the selected plurality of questions. For example, associate unique identifier instructions 136 may associate a unique identifier with the selected plurality of questions. The unique identifier may be associated with a student and/or may identify the order of questions. For example, the randomized order of the questions may be stored in a database table and associated with a unique identifier. Upon scanning the machine-readable code, the unique identifier may be used to retrieve the expected order of questions and/or answers. In some implementations, a student identifier may be associated with the selected plurality of questions. The student identifier may be pre-assigned before the test is given to the student and/or may be associated with the selected plurality of questions later, such as when the test is handed out and/or when the answers are returned by the student.

Method 400 may then advance to stage 425 where device 100 may add a machine-readable code of the unique identifier to the printable layout for each of the corresponding selected plurality of questions. For example, add code to layout instructions 138 may add a machine-readable code of the unique identifier to the printable layout. The machine-readable code may comprise, for example, a bar code, a matrix code, a text string, and a watermark. The machine-readable code may be visible to a person, such as a large bar code, and/or may not be readily visible, such as a translucent watermark and/or a set of steganography dots. The code may be used to identify the selected questions, a class period, a student, and/or additional information. In some implementations, the code may be added in multiple sections, such as a small matrix code at one and/or more of the corners of the page.

Method 400 may then end at stage 450.

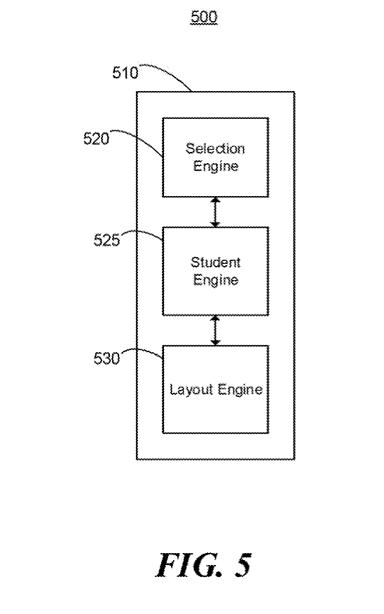

FIG. 5 is a block diagram of an example system 500 for providing test generation. System 500 may comprise a computing device 510 comprising a selection engine 520, a student engine 525 and a layout engine 530. Engines 520, 525, and 530 may be associated with a single computing device 510 and/or may be communicatively coupled among different devices such as via a direct connection, bus, or network. Each of engines 520, 525, and 530 may comprise hardware and/or software associated with computing devices.

Selection engine 520 may select at least a subset of questions from a list of available questions in a random order, wherein the list of available questions comprise a plurality of different question types. For example, selection engine 520 may execute select questions instructions 132 to select a plurality of questions in a random order. The plurality of questions may comprise, for example a multiple choice question, a short answer question, a free-form question, a sketch and/or drawing question, an essay question, a question that requires showing a process or solving work, a mathematics question, etc.

System 500 may, for example, use a random number generator to select from the list of available questions. A random number generator (RNG) may comprise a computational algorithm designed to generate a sequence of numbers that cannot be reasonably predicted better than by a random chance. For example, for available questions 1-30, a RNG may be used to generate a random number from 1 to 30; the generated number may become the first question. A second question may then be selected by using the RNG to generate a random number from 1 to 29. Alternately, another random number from 1 to 30 may be generated and a repeat simply ignored so that a new random number is generated. In some implementations, constraint rules may be applied. Such rules may state that a particular question be placed in a particular location, such as placing an essay question as the final question. Another rule may state that a particular question must precede another question, such as available question 3 should always follow available question 7. Selection of one of these questions may result in the constrained question from the rule being inserted into the question order as specified by the rule. For multiple choice questions, the RNG may similarly be used to randomize the order of the answer choices.

In some implementations, the instructions to select the plurality of questions in the random order further comprise instructions to randomize the selection of the plurality of questions for each of a plurality of students. For example, for each student, a newly randomized order of questions may be selected. For another example, a limited number of randomized order of questions may be prepared, such that some students may receive the same order (e.g., four sets of randomized questions may be prepared for a class of 16, such that every fourth student receives the same question order).

Questions may be stored in a question database associated with a teaching/instructional application. For example, an instructor may enter the questions in an app on their tablet and/or smart device, through a web-based user interface, through an application on a deskptop or laptop, etc. Each question may comprise the actual display information of the question (text, figures, drawings, references, tables, etc.), a question type (e.g., short answer, multiple choice, sketch, essay, etc.), and/or any constraint rules, as described above. For multiple-choice type questions, the answer choices may also be entered. The question type may be then be used to define an amount of space needed on a page. For example, a multiple choice question may require two lines for the question, an empty space line, and a line for the list of possible answers. For free-form and/or essay type questions, the instructor may enter a recommended amount of answer space (e.g., three lines, half a page, a full page, etc.). The instructor/teacher may also enter the correct answers into the application for later grading.

Student engine 525 may associate the selected subset of questions with a unique identifier associated with a student, wherein the unique identifier comprises an anonymized identifier for the student. For example, student engine 525 may perform associate unique identifier instructions 136 to associate a unique identifier with the selected plurality of questions. The unique identifier may be associated with a student and/or may identify the order of questions. For example, the randomized order of the questions may be stored in a database table and associated with a unique identifier. Upon scanning the machine-readable code, the unique identifier may be used to retrieve the expected order of questions and/or answers. In some implementations, a student identifier may be associated with the selected plurality of questions. The student identifier may be pre-assigned before the test is given to the student and/or may be associated with the selected plurality of questions later, such as when the test is handed out and/or when the answers are returned by the student.

Layout engine 530 may generate a printable layout of the selected subset of questions, wherein the printable layout comprises at least one indicator of a response area for at least one of the questions, and add a machine-readable code of the unique identifier to the printable layout. For example, layout engine 530 may perform generate layout instructions 134 to generate a printable layout of the selected plurality of questions. The instructions to generate the printable layout of the selected plurality of questions may further comprise instructions to create indicators for a pre-defined answer area for at least one of the plurality of questions. For example, a box may be drawn to indicate a sketch/drawing area and/or lines may be provided to indicate a free-form/short answer area. Other indicators may comprise arrows, bubbles, shading, number lines, etc. In some implementations, questions and answers may be laid out on different pages.

Layout engine 530 may perform add code to layout instructions 138 to add a machine-readable code of the unique identifier to the printable layout. The machine-readable code may comprise, for example, a bar code, a matrix code, a text string, and a watermark. The machine-readable code may be visible to a person, such as a large bar code, and/or may not be readily visible, such as a translucent watermark and/or a set of steganography dots. The code may be used to identify the selected questions, a class period, a student, and/or additional information. In some implementations, the code may be added in multiple sections, such as a small matrix code at one and/or more of the corners of the page.

The disclosed examples may include systems, devices, computer-readable storage media, and methods for test generation. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions to:
select a plurality of questions in a random order;
generate a printable layout of the selected plurality of questions;
associate a unique identifier with the selected plurality of questions; and
add a machine-readable code of the unique identifier to the printable layout.

2. The non-transitory machine-readable medium of claim 1, wherein the machine-readable code comprises at least one of a bar code, a matrix code, a text string, and a watermark.

3. The non-transitory machine-readable medium of claim 1, wherein the plurality of questions comprise at least one multiple choice question.

4. The non-transitory machine-readable medium of claim 1, wherein the plurality of questions comprise at least one free-form question.

5. The non-transitory machine-readable medium of claim 1, wherein the unique identifier comprises an anonymous identifier associated with a student.

6. The non-transitory machine-readable medium of claim 5, wherein the instructions to select the plurality of questions in the random order further comprise instructions to randomize the selection of the plurality of questions for each of a plurality of students.

7. The non-transitory machine-readable medium of claim 1, wherein the instructions to generate the printable layout of the selected plurality of questions further comprise instructions to create indicators for a pre-defined answer area for at least one of the plurality of questions.

8. A computer-implemented method, comprising:
selecting a plurality of questions in a random order for each of a plurality of students;
generating a printable layout for each of the selected plurality of questions;
associating a unique identifier for each of the plurality of students with the corresponding selected plurality of questions; and
adding a machine-readable code of the unique identifier to the printable layout for each of the corresponding selected plurality of questions.

9. The computer-implemented method of claim 8, wherein the plurality of questions comprises at least one free-form question.

10. The computer-implemented method of claim 9, wherein generating the printable layout comprises defining a response area for the at least one free-form question.

11. The computer-implemented method of claim 10, wherein generating the printable layout comprises adding a visual indicator of the defined response area to the printable layout.

12. The computer-implemented method of claim 8, wherein the machine-readable code further comprises information associated with the random order of the selected plurality of questions.

13. The computer-implemented method of claim 12, wherein the machine-readable code comprises at least one of a bar code, a matrix code, a text string, and a watermark.

14. The computer-implemented method of claim 8, wherein selecting the plurality of questions in the random order for each of the plurality of students comprises selecting a subset of an available list of questions.

15. A system, comprising:
a selection engine to:
select at least a subset of questions from a list of available questions in a random order, wherein the list of available questions comprise a plurality of different question types;
a student engine to:
associate the selected subset of questions with a unique identifier associated with a student, wherein the unique identifier comprises an anonymized identifier for the student; and
a layout engine to:
generate a printable layout of the selected subset of questions, wherein the printable layout comprises at least one indicator of a response area for at least one of the questions, and
add a machine-readable code of the unique identifier to the printable layout.
